(19) United States
(12) Patent Application Publication
(10) Pub. No.: US 2025/0256669 A1
(43) Pub. Date: Aug. 14, 2025

(54) INFORMATION PROCESSING DEVICE

(71) Applicant: TOYOTA JIDOSHA KABUSHIKI KAISHA, Toyota-shi (JP)

(72) Inventors: Rie MURAI, Chiba-shi (JP); Jun HIOKI, Nagakute-shi (JP); Tomonari YAMAGUCHI, Miyoshi-shi (JP)

(73) Assignee: TOYOTA JIDOSHA KABUSHIKI KAISHA, Toyota-shi (JP)

(21) Appl. No.: 18/953,469

(22) Filed: Nov. 20, 2024

(30) Foreign Application Priority Data
Feb. 8, 2024 (JP) 2024-017968

(51) Int. Cl. B60R 16/037; B60W 40/08

(52) U.S. Cl. CPC B60R 16/037; B60W 40/08; B60W 2040/0809

(57) ABSTRACT

The information processing device is an information processing device that applies a setting related to a user to an in-vehicle device, and includes a control unit that executes recognition of the user by one of a plurality of different kinds of recognition methods, and selection of a setting item to be applied to the in-vehicle device among a plurality of setting items indicating a setting related to the user according to the kind of the recognition method that the user has recognized.

### CROSS-REFERENCE TO RELATED APPLICATION

This application claims priority to Japanese Patent Application No. 2024-017968 filed on Feb. 8, 2024, incorporated herein by reference in its entirety.

### BACKGROUND

### 1. Technical Field

The present disclosure relates to devices that manage settings of an in-vehicle device.

### 2. Description of Related Art

A technique is known in which a user is identified and settings customized for the user are reflected in an in-vehicle device etc. In this regard, for example, Japanese Unexamined Patent Application Publication No. 2016-215817 (JP 2016-215817 A) discloses an electronic key system that identifies a user who gets into a vehicle by the user's mobile terminal and adjusts the seat position to the position corresponding to the user via a seat device.

### SUMMARY

An object of the present disclosure is to appropriately select a setting item to be applied to an in-vehicle device.

One aspect of an embodiment of the present disclosure is an information processing device that applies a setting related to a user to an in-vehicle device. The information processing device includes a control unit configured to: recognize the user by one of a plurality of different kinds of recognition methods; and select a setting item to be applied to the in-vehicle device from a plurality of setting items indicating the setting related to the user, according to a kind of a recognition method used to recognize the user.

Other aspects include a method that is performed by the above device, a program for causing a computer to perform the method, and a computer-readable storage medium storing the program in a non-transitory manner.

According to the present disclosure, it is possible to appropriately select a setting item to be applied to an in-vehicle device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of processing executed by an authentication device according to a first embodiment;

FIG. 2 is a diagram illustrating components included in the authentication device according to the first embodiment;

FIG. 3 is a flowchart of processing executed by a control unit of the authentication device according to the first embodiment;

FIG. 4 is a table showing the degree of reliability of a user recognition method according to the first embodiment;

FIG. 5 is a table showing the level of privacy of the setting items according to the first embodiment; and

FIG. 6 is a table showing the magnitude of the influence of the setting item according to the second embodiment on the safety of the vehicle.

### DETAILED DESCRIPTION OF EMBODIMENTS

### Overview

It is assumed that a user who rides on a vehicle is specified, and a setting tailored to the specified user is applied to an in-vehicle device or the like. At this time, the setting items (hereinafter, setting items) to be applied to the in-vehicle device and the like include a setting item having high privacy of the user, a setting item having a large influence on the safety of the vehicle, and the like. For example, the setting items such as the user name, the history of the destination, the position of the seat of the driver's seat, and the like are setting items having high privacy of the user or setting items having a large influence on the safety of the vehicle. Therefore, if these setting items are erroneously applied to another person, they are not preferable from the viewpoint of privacy protection and safety. Therefore, the application of these setting items to the in-vehicle device or the like is carefully performed, for example, permitted only when the user recognition is performed by the highly accurate recognition method.

However, in the related art, when user recognition is performed by a method that does not have a high degree of reliability, not only the setting items that must be carefully applied but also the setting items that have few problems even when applied are prevented from being applied to the in-vehicle device etc. That is, when the user recognition is performed by a method that does not have a high degree of reliability, it cannot be uniformly applied to the in-vehicle device up to a setting item having low privacy, a setting item having little influence on the safety of the vehicle, or the like. However, in a case where user recognition is performed in a method that does not have a high degree of reliability, it is desired that a setting item having low privacy or a setting item having little influence on the safety of the vehicle can be applied. In order to solve this problem, it is desirable for the apparatus to be able to flexibly select a setting item that can be applied to an in-vehicle device etc. according to the degree of reliability of the method of user recognition.

An information processing device according to the one aspect of the present disclosure includes a control unit configured to:
An information processing device that applies a setting related to a user to an in-vehicle device, comprising:
   recognizing the user in one of a plurality of different kinds of recognition methods;
   selecting the setting item to be applied to the in-vehicle device among a plurality of setting items indicating the setting related to the user according to a kind of a recognition method that the user has recognized.

An information processing device includes a control unit that executes:

The user recognition method is a method in which the information processing device according to the present disclosure recognizes who is the user who has ridden on the vehicle. Typically, a smartphone associated with a user, an electronic key of a vehicle on which an information processing device according to the present disclosure is mounted, and the like are used to recognize the user.

The setting related to the user is a setting individually determined for each user to be applied to various equipment provided in a vehicle such as an in-vehicle device or a seat. Specifically, the setting related to the user is a display setting of an in-vehicle device, a position of a seat or a handle of a driver's seat, or the like. The setting related to the user includes a plurality of setting items.

The control unit selects a setting item to be applied to the in-vehicle device or the like according to the kind of the recognition method used when the user is recognized. For example, when a more accurate recognition method is used, it is possible to select a setting item with high privacy and a setting item that affects safety. On the other hand, when a less accurate recognition method is used, a setting item with low privacy or a setting item that does not affect safety is selected.

Accordingly, the information processing device according to the present disclosure can flexibly select the setting item to be applied to the in-vehicle device or the like according to the recognition method of the user. That is, the information processing device according to the present disclosure can improve the convenience of the user in the application of the setting in the vehicle including the in-vehicle device or the like.

Further, each of the plurality of different recognition methods is associated with a degree of reliability when the recognition method is used to recognize the user.

The control unit may select the setting item to be applied to the in-vehicle device from the setting items, based on the degree of reliability of the recognition method.

The degree of reliability is a value indicating a height of a probability (that is, a height of recognition accuracy) that the user specified by the recognition method is the person who is in charge of the user recognition when the recognition method of a certain user is used. The higher the degree of reliability, the higher the possibility that the user identified by the recognition method of the user is the person who is in charge of the user recognition.

Thus, the information processing device according to the present disclosure can select an appropriate setting item according to the degree of reliability of the recognition method used for user recognition.

The control unit may determine to apply, to the in-vehicle device, a setting item having a greater influence on privacy of the user out of the setting items as the degree of reliability of the recognition method increases.

Thus, the information processing device according to the present disclosure can select a setting item having an appropriate level of privacy according to the degree of reliability of the user recognition method. For example, when the degree of reliability of the user's recognition method is low, a person different from the specified user may be riding on the vehicle. In this case, since the setting item related to the privacy of the specified user is applied to the in-vehicle device or the like, it is possible to prevent the personal information of the specified user from being inadvertently leaked to a third party.

The control unit may determine to apply, to the in-vehicle device, a setting item having a greater influence on safety of a vehicle on which the in-vehicle device is mounted out of the setting items as the degree of reliability of the recognition method increases.

Thus, the information processing device according to the present disclosure can select a setting item having a magnitude of an influence on safety of an appropriate vehicle according to the degree of reliability of the user recognition method. For example, when the degree of reliability of the user's recognition method is low, a person different from the specified user may be riding on the vehicle. In this case, it is possible to prevent a trouble in driving of the vehicle by applying a setting specialized for the specified user to the in-vehicle device or the like.

The recognition method is any of the following recognition method: electronic key recognition, digital key recognition, recognition by a Bluetooth (registered trademark) device, biometric recognition, and recognition based on an input operation by the user.

An electronic key is typically a key fob associated with a vehicle. The digital key is typically authentication data transmitted from the mobile terminal to the vehicle. The digital key may be transmitted from a Bluetooth device. The input operation by the user is typically an operation of setting the driver by the user himself/herself. The user may set a password associated with his/her account and input the password at the time of user recognition.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### First Embodiment

### Overview of the Processing of Authentication Equipment

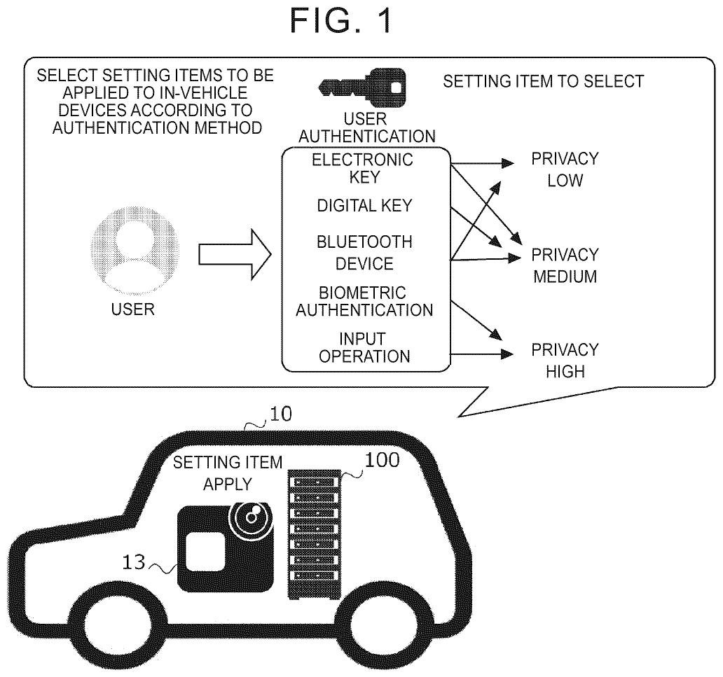

An outline of processing performed by the authentication device according to the embodiment will be described with reference to FIG. 1. FIG. 1 is a diagram illustrating an outline of processing executed by the authentication device 100 according to the first embodiment. Here, the authentication device 100 is an example of an information processing device according to the present disclosure. The authentication device 100 identifies a user who has ridden on the vehicle 10, and applies a setting associated with the user to the in-vehicle device or the like. In addition, the authentication device 100 may communicate with a database (described later) and acquire information on settings associated with the user. The authentication device 100 is typically implemented as an in-vehicle device mounted on the vehicle 10. The authentication device 100 may be controlled by a plurality of in-vehicle devices or a plurality of ECU mounted on the vehicle 10.

First, the authentication device 100 performs user recognition by one of a plurality of user recognition methods when the user rides on the vehicle 10. Examples of the user recognition method include electronic key recognition, digital key recognition, recognition by a Bluetooth (registered trademark) device, biometric recognition, and recognition based on an input operation by the user.

Next, the authentication device 100 selects a setting to be applied to the in-vehicle device or the like in accordance with the method of user recognition. For example, the authentication device 100 selects a setting having a different level of privacy as a setting to be applied in accordance with the degree of reliability of the user recognition method. Here, the degree of reliability of the method of user recognition is a value (i.e., recognition accuracy) indicating the height of the probability that the person identified as the user is the person who is in charge of the user recognition when the user recognition is performed.

For example, a case where user recognition is performed using an electronic key will be described. The electronic key is typically a key fob corresponding to the vehicle 10. For example, when the vehicle 10 is used by a plurality of persons, each may have its own electronic key. In this case, it is possible to estimate the riding user based on the identifier of the electronic key or the like. However, it is also possible that the electronic key possessed by one user is that of another user. In other words, the electronic key recognition is a recognition method in which the accuracy of identifying the person who has attended the user recognition by the electronic key is low or moderate. When user recognition is performed using an electronic key, the authentication device 100 selects a setting item with low privacy and a setting item with moderate privacy as a setting item to be applied to an in-vehicle device or the like. On the other hand, when user recognition is performed using an electronic key, the authentication device 100 does not select a setting item with high privacy as a setting item to be applied to an in-vehicle device or the like.

That is, when the user recognition is performed by the recognition method with a low or medium degree of reliability, the authentication device 100 does not apply the setting item with high privacy to the in-vehicle device or the like among the setting items associated with the user specified by the user recognition. This is because it is not preferable from the viewpoint of privacy protection of the user to apply a setting item having a high privacy property to the in-vehicle device or the like when there is a certain possibility that the specified user is not the person who has ridden on the vehicle 10. Then, the authentication device 100 applies the selected setting item to the in-vehicle device or the like.

As described above, in the first embodiment, when there is a possibility that the user identified by the user recognition is not the person who has performed the recognition, the authentication device 100 extracts the setting items with high privacy and does not apply them to the in-vehicle device or the like. The setting item applied to the in-vehicle device or the like varies depending on the degree of reliability of the method used for user recognition. With such a configuration, the authentication device 100 can flexibly select the setting item to be applied to the in-vehicle device etc. according to the degree of reliability of the method of user recognition.

### Configuration of the Authentication Device

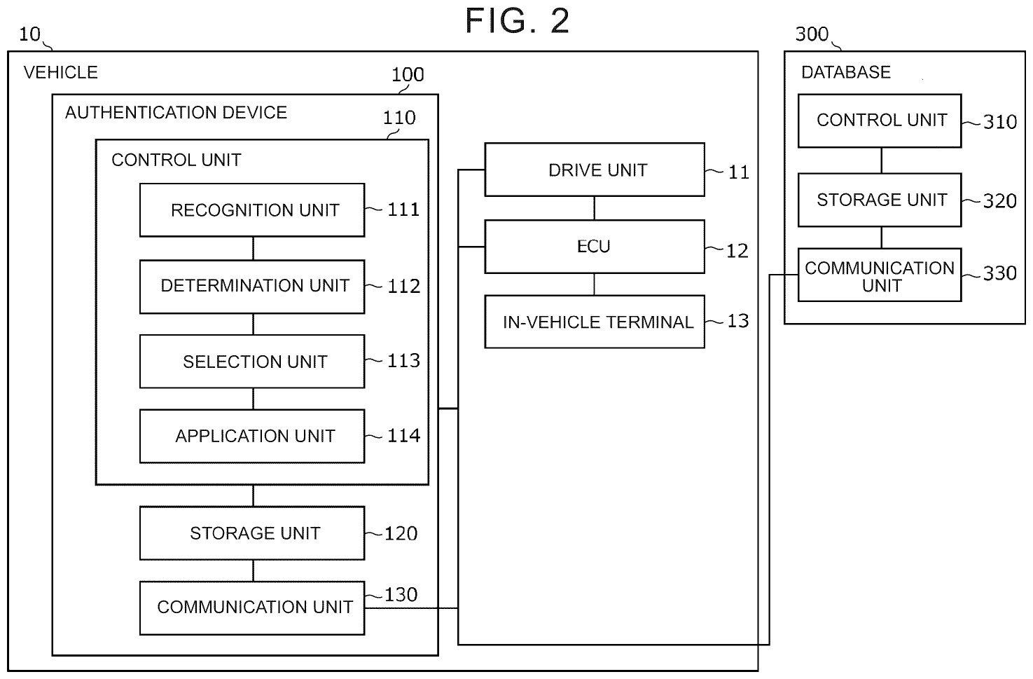

FIG. 2 is a diagram illustrating components of the authentication device 100 according to the first embodiment. In FIG. 2, the authentication device 100 may be implemented by a computer mounted with one or more in-vehicle devices mounted on the vehicle 10.

The authentication device 100 according to the present embodiment includes a control unit 110, a storage unit 120, and a communication unit 130. The authentication device 100 is mounted on the vehicle 10. The authentication device 100 may be mounted on the vehicle 10, and may be incorporated in a device that can perform settings related to travel support of the vehicle 10, guide a route, adjust an in-vehicle environment, and the like. The authentication device 100 may be a terminal for a car navigation system installed in a driver's seat. The authentication device 100 may include a display, an input unit, and an audio output unit. Alternatively, the authentication device 100 may include an audio output unit and a touch panel display to receive an input from a user. Alternatively, the authentication device 100 may be any in-vehicle terminal other than a terminal for car navigation.

The control unit 110 is implemented by a processor such as a CPU (Central Processing Unit) or a GPU (Graphics Processing Unit) and a memory. The control unit 110 includes a recognition unit 111, a determination unit 112, a selection unit 113, and an application unit 114 as functional modules. These functional modules may be realized by executing a program by the control unit 110.

The recognition unit 111 recognizes a user who uses the vehicle 10. The recognition unit 111 recognizes the user by one of a plurality of existing recognition methods. Note that the recognition unit 111 may perform user recognition by combining some of a plurality of existing recognition methods. The plurality of known recognition methods may include, for example, electronic key recognition, digital key recognition, recognition by a Bluetooth device, biometric recognition, and an input operation by the user. The digital key is authentication data transmitted from a mobile terminal or the like possessed by the user to the authentication device 100. Since the portable terminal is highly likely to be carried by the owner, it can be said that the degree of reliability of the portable terminal is relatively higher than that of the electronic key. Further, Bluetooth (registered trademark) device is, for example, an information terminal such as a smart phone or a tablet terminal. Bluetooth device is likely to be carried by the user of the vehicle 10, but the vehicle 10 does not necessarily detect Bluetooth device carried by the user. For example, the vehicle 10 may detect a Bluetooth device carried by another person in the vicinity that differs from the user riding in the vehicle 10. Therefore, the degree of reliability of Bluetooth device is considered to correspond to the degree of reliability (low to medium) of the electronic key.

The determination unit 112 determines the degree of reliability of the method used by the recognition unit 111 for recognition. Here, the degree of reliability of the method used for the recognition is a value indicating the level of the probability that the recognition unit 111 can correctly identify the person who is in charge of the user recognition. The degree of reliability of the method used for the recognition may be the probability of correctly identifying the person who is attending the user recognition, or may be a numerical value or a character string representing the degree of correctly identifying the person who is attending the user recognition in a multi-step evaluation. The determination unit 112 performs the above determination with reference to data indicating a predetermined degree of reliability for each of the recognition methods that can be used by the recognition unit 111 for recognition. For example, the determination unit 112 may refer to data representing the degree of reliability stored in the storage unit 120, or may refer to data representing the degree of reliability stored in the storage unit 320 of the database 300. In addition, the determination unit 112 may refer to data representing the degree of reliability stored in an external storage device other than the above.

The selection unit 113 selects a setting item to be applied to an in-vehicle device or the like according to the degree of reliability of the recognition method determined by the determination unit 112. For example, when the degree of reliability of the recognition method is high, the selection unit 113 selects, as a setting item to be applied to an in-vehicle device or the like, a setting item having a high privacy property in addition to a setting item having a low privacy property. On the other hand, when the degree of reliability of the recognition method is low, the selection unit 113 selects only the setting item with low privacy as the setting item to be applied to the in-vehicle device or the like.

The application unit 114 applies the setting indicated by the setting item selected by the selection unit 113 to the in-vehicle device or the like. The application unit 114 communicates with the in-vehicle device or the like, transmits information on a setting item to be applied to the in-vehicle device or the like, and instructs the in-vehicle device to apply the setting. The in-vehicle device may be a device that provides information to a user, such as the in-vehicle terminal 13, or may be a device that controls vehicles, such as an ECU 12.

The storage unit 120 is an auxiliary storage device such as a main storage device such as a RAM or a ROM, a EPROM, a hard disk drive, and a removable medium. The secondary storage device stores an operating system (OS), various programs, various tables, and the like, and by executing the programs stored therein, it is possible to realize the respective functions matching the predetermined objectives of the respective units of the control unit 110. However, some or all of the functions may be implemented by a hardware circuit such as an ASIC or an FPGA.

The storage unit 120 stores data or the like used or generated in processing performed by the control unit 110. Further, the storage unit 120 may store information on the degree of reliability of the recognition method, the level of privacy of the setting item, the level of influence of the setting item on the safety of the vehicle, and the like.

The communication unit 130 includes a communication circuit that performs wireless communication. The communication unit 130 may be, for example, a communication circuit that performs wireless communication using 4G (4th Generation) or a communication circuit that performs wireless communication using 5G (5th Generation). The communication unit 130 may be a communication circuit that performs radio communication using LTE (Long Term Evolution) or a communication circuit that performs communication using LPWA (Low Power Wide Area). Further, the communication unit 130 may be a communication circuit that performs radio communication using Wi-Fi (registered trademark).

Next, components other than the authentication device 100 mounted on the vehicle 10 will be described.

The drive unit 11 is a means for causing the vehicle 10 to travel. The drive unit 11 may include, for example, a motor, an inverter, a brake, and a steering mechanism for driving wheels. The drive unit 11 may be operated by electric power supplied from a driving battery.

ECU 12 is an electronic control unit that is a computer for realizing various functions required for traveling of the vehicles 10. A plurality of ECU 12 may be mounted. ECU 12 may execute a part of the operation performed by the authentication device 100 in response to an instruction from the authentication device 100. For example, ECU 12 may determine the degree of reliability of the user recognition methods in response to an instruction from the determination unit 112. ECU 12 may be a device (such as a body ECU) that controls a device (such as a seat actuator) included in the vehicles 10. In this case, ECU 12 may apply the setting to the device of the vehicle 10 related to the setting in response to an instruction from the application unit 114 so as to apply the setting indicated by the setting item selected by the selection unit 113 among the settings inside the vehicle. The in-vehicle internal setting is a setting related to traveling such as a position of a seat of a driver's seat or a position of a handle.

The in-vehicle terminal 13 is a terminal that receives an input of a setting necessary for traveling of the vehicle 10 and provides a car navigation system to a driver. The in-vehicle terminal 13 may include a display. The in-vehicle terminal 13 receives, from the application unit 114, the application of the settings such as the various settings in the car navigation system selected by the selection unit 113, the air-conditioning settings of the vehicle 10, and the volume setting of the in-vehicle terminal 13, and reflects them in the corresponding various devices.

### Device Other Than the Authentication Device

Next, the database 300 will be described.

The database 300 is a storage device that stores information indicating a setting item for each user, which is referred to by the authentication device 100. The database 300 includes a control unit 310, a storage unit 320, and a communication unit 330.

The control unit 310 is implemented by a processor such as a CPU or a GPU and memories. Each of the functional modules included in the control unit 310 may be realized by executing a program by the control unit 310.

For example, in response to a request from the authentication device 100, the control unit 310 acquires a setting item corresponding to the designated user from the storage unit 320, and transmits the setting item to the authentication device 100.

The storage unit 320 stores the above-described information indicating the setting item for each user.

The storage unit 320 is an auxiliary storage device such as a main storage device such as a RAM or a ROM, an EPROM, a hard disk drive, and a removable medium. The secondary storage device stores an operating system (OS), various programs, various tables, and the like, and by executing the programs stored therein, it is possible to realize the respective functions matching the predetermined objectives of the respective units of the control unit 310. However, some or all of the functions may be implemented by a hardware circuit such as an ASIC or an FPGA.

The communication unit 330 includes a communication circuit that performs wireless communication. The communication unit 330 may be, for example, a communication circuit that performs wireless communication using a 4G or a communication circuit that performs wireless communication using a 5G. The communication unit 330 may be a communication circuit that performs radio communication using an LTE, or may be a communication circuit that performs communication using a LPWA. Further, the communication unit 330 may be a communication circuit that performs radio communication using Wi-Fi (registered trademark).

### Operation of the Authentication Device

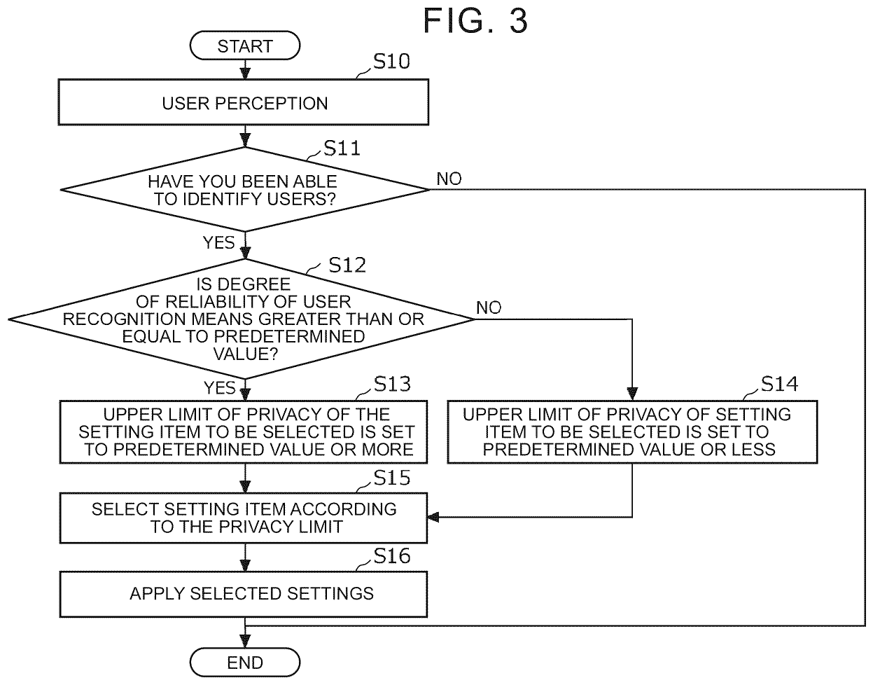

Next, specific contents of the processing performed by the authentication device 100 will be described. FIG. 3 is a flowchart of processing executed by the control unit 110 of the authentication device 100 according to the first embodiment.

Before the illustrated processing is started, the recognition unit 111 of the authentication device 100 is in a standby state and is always in a state in which a wireless signal or the like used to recognize the user can be detected. The process of S10 is started when the recognition unit 111 detects a radio signal or the like used for recognition by the user, or when there is some input related to the recognition by the user from an input device mounted on the vehicle 10.

First, in S10, the recognition unit 111 recognizes a user. The recognition unit 111 corresponds to a plurality of recognition methods such as electronic key recognition, digital key recognition, recognition using a Bluetooth (registered trademark) device, biometric recognition, and recognition based on an input operation by the user. The recognition unit 111 detects a wireless signal used in the above-described recognition method, an input signal from a corresponding input device, or the like, and identifies a user who intends to use the vehicle 10. The recognition based on the input operation of the user is a recognition method for specifying the user based on the content input by the user himself/herself on a predetermined user interface screen.

Subsequently, in S11, the recognition unit 111 determines whether or not the user has been identified. The recognition unit 111 determines whether or not the user has been identified as a specific user by recognizing the user in S10. In this step, when the recognition unit 111 determines that the user has been identified, an affirmative determination is made.

If an affirmative determination is made in this step, the process proceeds to S12.

If a negative determination is made in this step, the process ends.

When the process transitions to S12, the determination unit 112 determines whether or not the degree of reliability of the unit (recognition method) used by the recognition unit 111 for recognition by the user is equal to or greater than a predetermined value. Here, the degree of reliability is a value indicating a degree of certainly identifiability of a person who intends to recognize the user when the user is recognized by using a recognition method of a certain user. The determination unit 112 determines whether the degree of reliability of the recognition method is equal to or greater than a predetermined value by referring to a predetermined storage area or the like in which the degree of reliability of the recognition method determined in advance is recorded. The determination unit 112 may refer to the information on the degree of reliability of the recognition method of the user stored in the storage unit 120. Further, the determination unit 112 may communicate with the database 300 and refer to the information on the degree of reliability of the user recognition method stored in the storage unit 320 of the database 300. In this step, when the determination unit 112 determines that the degree of reliability of the method used by the recognition unit 111 for recognition is equal to or greater than a predetermined value, an affirmative determination is made.

If an affirmative determination is made in this step, the process transitions to S13.

If a negative determination is made in this step, the process transitions to S14.

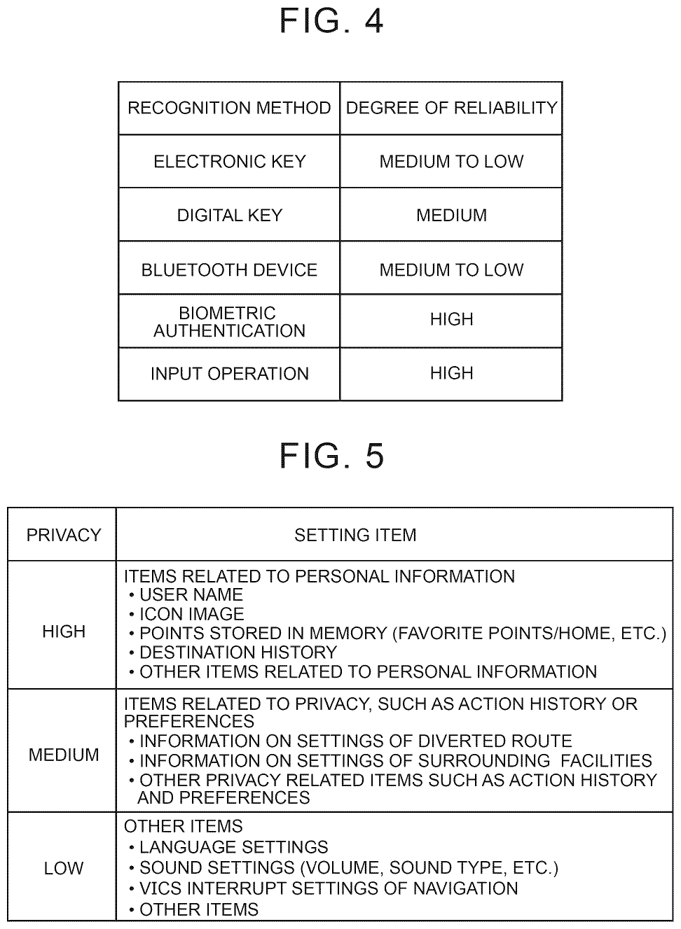

FIG. 4 is a table showing the degree of reliability of a user recognition method according to the first embodiment. As shown in Table 1, for example, the electronic key is defined as having a medium to low degree of reliability. In the case of recognition by the user using the electronic key, since there are only a few electronic keys, there is a high possibility that the user himself/herself specified by the recognition unit 111 is using the electronic key. However, the possibility that a person other than the user himself/herself identified by the recognition unit 111 uses the electronic key cannot be excluded. Therefore, the degree of reliability of the electronic key is determined as shown in FIG. 4. In addition, in the case of biometric authentication, in order to identify a face, a voice print, an iris, a fingerprint, or the like, a user who is facing user recognition has an extremely high probability of being the user himself/herself identified by the recognition unit 111. Therefore, as shown in FIG. 4, the degree of reliability of biometric authentication is determined to be high. The recognition method of other users is also determined as shown in FIG. 4 under the same concept.

When the process transitions to S13, the selection unit 113 sets the upper limit of the privacy level of the setting items to be selected to a predetermined value or more. Here, for example, the level of privacy may be represented by three levels, high, medium, and low, or may be represented by more levels. The selection unit 113 may refer to information on the level of privacy of the setting item stored in the storage unit 120. In addition, the selection unit 113 may communicate with the database 300 and refer to information on the level of privacy of the setting item stored in the storage unit 320 of the database 300. Thus, when the degree of reliability of the method of recognizing the user is higher than or equal to the predetermined value, the selection unit 113 can select a setting item with high privacy to some extent as a setting item to be applied to an in-vehicle device or the like. That is, as the degree of reliability of the user's recognition method is higher, the selection unit 113 can select a setting item having a larger influence on the privacy of the user as a setting item to be applied to the in-vehicle device or the like.

FIG. 5 is a table showing the level of privacy of the setting item according to the first embodiment. As illustrated in FIG. 5, for example, an item related to personal information is defined as a setting item having high privacy. As an example, the user name (for example, the name of the person himself/herself) and the icon image (for example, the face image of the person himself/herself) are determined as setting items with high privacy. In addition, a point (for example, a favorite point of a user, a home of a user, or the like) stored in a memory of an in-vehicle device that provides a car navigation system or the like, a history of a point registered as a destination of the user, or the like is also determined as a setting item with high privacy. Further, an item related to privacy such as an action history or a preference is defined as a setting item having a medium level of privacy. As an example, in the car navigation system, information related to setting of a detour route, information related to setting of a surrounding facility guided at a traveling position, and the like are determined as setting items with moderate privacy. The other items are determined as setting items with low privacy. For example, the setting of the user interface (UI), the setting of the sound (such as the volume or the type of sound), the setting of VICS (registered trademark) (Vehicle Information and Communication System) interrupt in the car navigation system, and the like in the in-vehicle terminal including the authentication device 100 and the like are determined as the setting items with low privacy.

When the process transitions to S14, the selection unit 113 sets the upper limit of the privacy level of the setting items to be selected to a predetermined value or less. As a result, the selection unit 113 cannot select a setting item with a higher degree of privacy as a setting item to be applied to an in-vehicle device or the like.

Next, in S15, the selection unit 113 selects the setting items according to the privacy-related upper limit set by S13 or S14. That is, the selection unit 113 selects the setting item according to the magnitude of the influence of the setting item on the privacy of the user.

Next, in S16, the application unit 114 applies the setting items selected by the selection unit 113 in S15 to the in-vehicle device or the like (for example, the in-vehicle terminal 13). The application unit 114 applies, with respect to the setting item selected by the selection unit 113, the contents of the setting determined corresponding to the user specified by the recognition unit 111 with respect to the setting item to the equipment of the vehicle, the in-vehicle device, or the like.

As a result, in the first embodiment, the authentication device 100 can select the setting item with higher privacy of the setting item as the setting item to be applied to the in-vehicle device as the reliability of the user recognition method is higher. That is, when the reliability of the user recognition method is low, only the setting item with low privacy is selected, and when the reliability of the user's recognition method is high, in addition to the setting item with low privacy, it is possible to select the setting item with high privacy.

Therefore, the authentication device 100 is more likely to be able to appropriately apply the setting of the in-vehicle device or the like individually set for each user in consideration of privacy. Therefore, when the degree of reliability of the recognition unit of the user is low, the authentication device 100 may uniformly prohibit the selection of the setting item with low privacy as well as the setting item with high privacy, so that only the setting item with low privacy can be selected. That is, the authentication device 100 can flexibly select a setting item to be reflected on the in-vehicle device or the like.

### Second Embodiment

### Selecting Safety-Considered Setting Items

In the first embodiment, the authentication device 100 selects a setting item with higher privacy as a setting item to be applied to an in-vehicle device or the like as the degree of reliability of the user recognition method is higher. However, when the degree of reliability of the user's recognition method is not high, not only the setting item having high privacy but also the setting item having a large influence on the safety of the vehicle is not suitable as the setting item to be applied to the in-vehicle device or the like. For example, when a seat position, a mirror position, or the like that is not suitable for the driver is set, the traveling safety of the vehicle may deteriorate. Therefore, in the second embodiment, the authentication device 100 selects a setting item having a larger influence on the safety of the vehicle 10 as a setting item to be applied to the in-vehicle device or the like as the degree of reliability of the recognition method of the user is higher.

Similar to S12 described in FIG. 3, the determination unit 112 determines whether the degree of reliability of the methods used by the recognition unit 111 for recognition by the user is equal to or greater than a predetermined value. The degree of reliability is determined based on, for example, the degree of reliability of the recognition method illustrated in FIG. 4. When the determination unit 112 determines that the degree of reliability of the method used by the recognition unit 111 for recognition by the user is equal to or more than a predetermined value, the selection unit 113 sets an upper limit of the magnitude of the influence on the safety of the vehicle 10 of the setting item to be selected to be equal to or more than a predetermined value. Here, for example, the magnitude of the influence on the safety of the vehicle 10 may be represented by three levels, large, medium, and small, or may be represented by more multiple stages. The selection unit 113 may refer to the information on the magnitude of the influence of the setting item stored in the storage unit 120 on the safety of the vehicle 10. In addition, the selection unit 113 may communicate with the database 300 and refer to the information on the magnitude of the influence of the setting item stored in the storage unit 320 of the database 300 on the safety of the vehicle 10. As a result, the selection unit 113 can select a setting item that has a large influence on the safety of the vehicle 10 to some extent as a setting item to be applied to an in-vehicle device or the like. That is, the selection unit 113 can select a setting item having a larger influence on the safety of the vehicle 10 as a setting item to be applied to the in-vehicle device or the like as the degree of reliability of the recognition method of the user is higher.

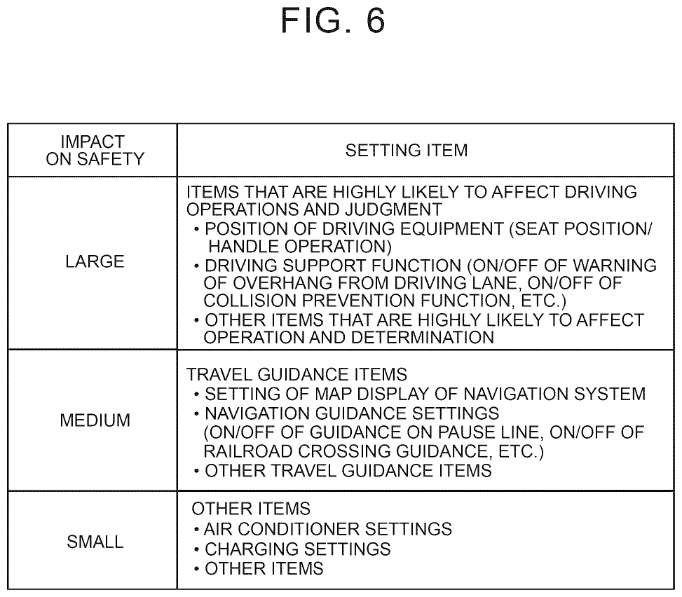

FIG. 6 is a table showing the magnitude of the influence of the setting item according to the second embodiment on the safety of the vehicle. As illustrated in FIG. 6, for example, an item having a high possibility of affecting the driving operation and judgment is defined as a setting item having a large influence on the safety of the vehicle 10. As an example, the information indicating the position of the equipment for driving, such as the position of the seat or the position of the steering wheel of the driver's seat in the vehicle 10, is determined as a setting item having a large influence on the safety of the vehicle 10. Further, a travel assistance function including on/off of a function for warning that the vehicle is protruding from the travel lane, on/off of a collision prevention function, and the like is also defined as a setting item that has a large influence on safety of the vehicle 10. On the other hand, the item related to the travel guidance is defined as a setting item having a moderate influence on the safety of the vehicle 10. As an example, in the car navigation system, setting of a map display, setting of guidance items such as on/off of guidance of a pause line or on/off of guidance of a railroad crossing, and the like are determined as setting items having a moderate influence on safety of the vehicle 10. The other items are set as setting items having a small influence on the safety of the vehicle 10. As an example, various settings such as the temperature, the air volume, and the like of the air conditioner, settings related to charging of the vehicle 10, and the like are determined as setting items having a small influence on the safety of the vehicle 10.

If the determination unit 112 determines that the degree of reliability of the method used by the recognition unit 111 for recognition by the user is equal to or less than a predetermined value, the selection unit 113 sets an upper limit of the magnitude of the influence on the safety of the vehicle 10 of the setting item to be selected to be equal to or less than a predetermined value. As a result, the selection unit 113 cannot select, as the setting item to be applied to the in-vehicle device or the like, the setting item having a large influence on the safety of the vehicle 10 to some extent or more.

Next, the selection unit 113 selects the setting item according to the set upper limit of the magnitude of the influence on the safety of the vehicle 10. That is, the selection unit 113 selects the setting item according to the magnitude of the influence of the setting item on the safety of the vehicle 10 of the user.

Next, the application unit 114 applies the selected setting item to the in-vehicle device or the like. The application unit 114 applies, with respect to the setting item selected by the selection unit 113, the contents of the setting determined corresponding to the user specified by the recognition unit 111 with respect to the setting item to the equipment of the vehicle, the in-vehicle device, or the like.

Thus, in the second embodiment, the authentication device 100 can select, as the setting item to be applied to the in-vehicle device, the setting item whose influence on the safety of the vehicle 10 is greater as the reliability of the user recognition method is higher. Therefore, the authentication device 100 is more likely to be able to appropriately apply the setting of the in-vehicle device or the like individually set for each user in consideration of the safety of the vehicle 10.

### The Third Embodiment

### Selecting Settings That Consider Both Privacy and Security

In the first embodiment, the level of privacy of the setting item is taken into consideration as a criterion for the authentication device 100 to select the setting item. Further, in the second embodiment, as a criterion for the authentication device 100 to select the setting item, the magnitude of the influence of the setting item on the safety of the vehicle 10 is taken into consideration. On the other hand, in the third embodiment, as a criterion for the authentication device 100 to select the setting item, both the high privacy of the setting item and the magnitude of the influence on the safety of the vehicle 10 are comprehensively taken into consideration.

Similar to S12 described in FIG. 3, the determination unit 112 determines whether the degree of reliability of the methods used by the recognition unit 111 for recognition by the user is equal to or greater than a predetermined value. The degree of reliability is determined based on, for example, the degree of reliability of the recognition method illustrated in FIG. 4. When the determination unit 112 determines that the degree of reliability of the method used by the recognition unit 111 for recognition by the user is equal to or greater than the predetermined value, the selection unit 113 sets the upper limit of the evaluation value of the setting item to be selected to be equal to or greater than the predetermined value. Here, the evaluation value is a value obtained by evaluating the setting items in consideration of both the level of privacy of the vehicle 10 and the level of influence on safety. The evaluation value is greatest when the privacy is high and when the influence on the safety of the vehicle 10 is large. For example, the magnitude of the evaluation value may be represented by three levels, large, medium, and small, or may be represented by a larger number of stages.

The selection unit 113 may refer to the information on the evaluation value of the setting item stored in the storage unit 120, or may communicate with the database 300 and refer to the information on the evaluation value of the setting item stored in the storage unit 320 of the database 300. As a result, the selection unit 113 can select a setting item having high privacy to a certain extent and a setting item having a large influence on the safety of the vehicle 10 as a setting item to be applied to an in-vehicle device or the like. That is, the selection unit 113 can select a setting item having higher privacy and a setting item having a larger influence on the safety of the vehicle 10 as a setting item to be applied to the in-vehicle device or the like as the degree of reliability of the user recognition method is higher.

When the determination unit 112 determines that the degree of reliability of the method used by the recognition unit 111 for recognition by the user is equal to or less than the predetermined value, the selection unit 113 sets the upper limit of the evaluation value of the setting item to be selected to be equal to or less than the predetermined value. As a result, the selection unit 113 cannot select a setting item having a higher degree of privacy and a setting item having a larger degree of influence on the safety of the vehicle 10 as a setting item to be applied to an in-vehicle device or the like.

Next, the selection unit 113 selects a setting item according to the upper limit of the evaluation value set as described above. That is, the selection unit 113 selects the setting item according to the level of privacy of the setting item and the magnitude of the influence of the setting item on the safety of the vehicle 10 of the user.

Next, the application unit 114 applies the selected setting item to the in-vehicle device or the like. The application unit 114 applies, with respect to the setting item selected by the selection unit 113, the contents of the setting determined corresponding to the user specified by the recognition unit 111 with respect to the setting item to the equipment of the vehicle, the in-vehicle device, or the like.

Thus, in the third embodiment, the authentication device 100 can select, as the setting item to be applied to the in-vehicle device, the higher the reliability of the user recognition method, the higher the privacy setting item and the setting item that has a large influence on the safety of the vehicle 10 of the setting item. Therefore, the authentication device 100 is more likely to appropriately apply the setting of the in-vehicle device or the like individually set for each user in consideration of both privacy and safety.

### Other Embodiments

The above-described embodiment is merely an example, and the present disclosure may be appropriately modified and implemented without departing from the scope thereof.

The high privacy of the setting item, the magnitude of the influence on the safety of the vehicle 10, the evaluation value in consideration thereof, and the like may not be fixed values. If the values are changed according to the situation, the user may communicate with an external server device (typically database 300) via communication unit 130 of authentication device 100 and download information about the changed values. Alternatively, the user may install information about the changed values on the authentication device 100 from an external medium (such as a USB memory).

Further, in the above-described embodiment, the determination of the degree of reliability of the recognition method of the user is performed when the user is recognized for the first time by the authentication device 100, but the determination of the degree of reliability of the recognition method of the user is not limited to the first time when the user is recognized. During traveling of the vehicle 10, the user recognition may be regularly redone at predetermined intervals, and if the user is recognized in another way than the previous time, the determination of the degree of reliability of the user recognition method may also be updated.

Alternatively, when the user attempts to apply a specific setting item to the in-vehicle device, the user may perform user authentication again, and the setting item applicable to the in-vehicle device or the like may be re-selected based on the degree of reliability of the user recognition method. The specific setting item is an item having high privacy, an item having a large influence on the safety of the vehicle 10, or a setting item having a high evaluation value in consideration of these items.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device that applies a setting related to a user to an in-vehicle device, the information processing device comprising a control unit configured to
recognize the user by one of a plurality of different kinds of recognition methods, and
select a setting item to be applied to the in-vehicle device from a plurality of setting items indicating the setting related to the user, according to a kind of a recognition method used to recognize the user.

2. The information processing device according to claim 1, wherein
a degree of reliability when the recognition method is used to recognize the user is associated with each of the different recognition methods, and
the control unit selects the setting item to be applied to the in-vehicle device from the setting items, based on the degree of reliability of the recognition method.

3. The information processing device according to claim 2, wherein the control unit determines to apply, to the in-vehicle device, a setting item having a greater influence on privacy of the user out of the setting items as the degree of reliability of the recognition method increases.

4. The information processing device according to claim 2, wherein the control unit determines to apply, to the in-vehicle device, a setting item having a greater influence on safety of a vehicle on which the in-vehicle device is mounted out of the setting items as the degree of reliability of the recognition method increases.

5. The information processing device according to claim 1, wherein the recognition method is any of the following recognition method: electronic key recognition, digital key recognition, recognition by a Bluetooth (registered trademark) device, biometric recognition, and recognition based on an input operation by the user.
